(19) United States
(12) Patent Application Publication
(10) Pub. No.: US 2010/0120002 A1
(43) Pub. Date: May 13, 2010

(54) System And Method For Conversation Practice In Simulated Situations

(76) Inventors: Chieh-Chih Chang, Taoyuan (TW); Sen-Chia Chang, Hsinchu (TW); Chung-Jen Chiu, Hsinchu (TW); Jian-Yung Hung, Taipei (TW); Lin-Chi Huang, Jhanghua (TW)

Correspondence Address: LIN & ASSOCIATES INTELLECTUAL PROPERTY, INC., P.O. BOX 2339, SARATOGA, CA, 95070-0339, US

(21) Appl. No.: 12/549,354

(22) Filed: Aug. 27, 2009

(30) Foreign Application Priority Data
Nov. 13, 2008 (TW) 097143963

(51) Int. Cl. G09B 19/04

(52) U.S. Cl. 434/185

(57) ABSTRACT

Disclosed is a system and method for conversation practice in simulated situations. The system comprises situational conversation teaching material, an audio processing module and a conversation processing module. The teaching material consists of multi-flow conversation paths and conversational sentences with a plurality of replaceable vocabulary items. According to different contents of the situational conversation teaching material and biased data of the teaching material, the audio processing module dynamically adjusts speech recognition model and recognizes the inputted audio signal of the learners to determine the information on the recognition results. The conversation processing module determines the information in response to the learners, based on the information on the recognition results, the situational conversation teaching material and biased data of the teaching material.

### TECHNICAL FIELD

The disclosure generally relates to a system and method for conversation practice in simulated situations.

### BACKGROUND

There exist many varieties of digital systems for conversation practice in simulated situations, such as, script of a conversation, and conversation audio material for learners. A digital teaching material may be usually divided into four types: (1) text and graphic-based, simply displaying text and graphic to the learners, (2) audio-based, by using demonstrated sound of auditory sentence recording able to be played through a player, such as CD/MP3 player, (3) video/audio presentation-based, recording the auditory sentence and the pronunciation image able to be played through a player, such as VCD/DVD player, and (4) computer-based interactive learning software, for the learners to interact with the edited learning material.

When using the types (1)-(3) for language learning, the learners usually are shown with the edited course through a playing device, such as the exemplary flow for the conversation material shown in FIG. 1. The learner simply repeats the listening and follows the script. In this manner, the learner may only practice the same sentences. Because there are different ways to express the meaning for a same sentence, a learner usually has a hard time to response when the learner is exposed to the actual conversational situation for dialogue and the other use the sentences different from those in the script. Therefore, the language learning using these types of materials usually shows limited results.

On the other hand, learning by using computer-based interactive software, the learner and the instructor may have certain extent of interaction. Hence, in a specific environment, the learner may practice repeatedly, and obtain feedback from the interaction through the computer analysis capability.

For example, Taiwan Patent No. 468120 disclosed a system and method for learning foreign language verbally. When the system asks a question, the learner may choose an answer from the audio provided by the system. The sentences in the audio are well designed and cover a wide range of different expressions. Taiwan Patent Publication No. 200506764 disclosed an interactive language learning method with language recognition. The user may use audio for response. The response sentence is a fixed sentence set by the system, without description of the conversation flow. Taiwan Patent No. 583609 disclosed a learning system and method with situational character selection and sentence-making, providing the user with selection of character and conversation situation so that the user may learn by following the flow arranged by the system.

China Patent Publication No. CN 1720520A disclosed a robotic apparatus with customized conversation system. The system records all the personal information and conversation history of a specific user, and applies all the information to the future conversation of the user. China Patent Publication No. CN 1881206A disclosed a conversation system able to process the user's re-input appropriately. The system stores the user's conversation history. When the user is in difference situation and requires the same information, the conversation system may obtain the related information with re-input without inquiring the user again.

U.S. Pat. No. 5,810,599 disclosed an interactive audio-video foreign language skills maintenance system. The system may play and pause the pre-prepared multimedia information to achieve the interaction. U.S. Pat. No. 70,522,798 disclosed an automated language acquisition system and method. Based on the hint such as graphic, the user may speak the pre-set words, phrases and sentences in the learning material to perform the evaluation of the user's pronunciation. However, the interactive conversation between different roles is not described.

U.S. Pat. No. 7,149,690 disclosed a method and apparatus for interactive language instruction. According to the sentences inputted by the user, the apparatus may generate conversation images and evaluate the user's pronunciation. However, the dialogue design of the interactive conversation flow is not disclosed. U.A. Patent Publication No. 20060177802 disclosed an audio conversation device, method, and robotic system to allow the user to converse with the system through audio. The dialogue and the path are pre-defined sentences and flows, and there is no biased error related processing included in the system.

### SUMMARY

The disclosed exemplary embodiments may provide a system and method for conversation practice in simulated situations.

In an exemplary embodiment, the disclosed is directed to a system for conversation practice in simulated situations. The system may comprise a situational conversation teaching material, an audio processing module and a conversation processing module. The teaching material consists of multi-flow dialogue paths and dialogue sentences with a plurality of replaceable vocabulary items. The audio processing module dynamically adjusts a speech recognition model according to different contents of the situational conversation teaching material, and recognizes the inputted audio signal of the learners to determine the information on the recognition results. The audio processing module may further refer to biased error information of the teaching material, or synonymy information of the teaching material or any combination of the two of the above, to dynamically adjust the speech recognition mode. The conversation processing module determines the information in response to the learners, based on the information on the recognition results and the situational conversation teaching material.

In another exemplary embodiment, the disclosed is directed to a method for conversation practice in simulated situations, comprising: preparing a situational teaching material with multi-flow dialogue paths and dialogue sentences having a plurality of replaceable vocabulary items; dynamically adjusting a speech recognition model according to different contents of the situational conversation teaching material, and recognizes the inputted audio signal of the learners to determine the information on the recognition results; the adjustment of speech recognition model may further referring to biased error information of the teaching material, or synonymy information of the teaching material or any combination of the two of the above; and determining the information in response to the learners, based on the information on the recognition results and the situational conversation teaching material.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of an exemplary conversation flow of a conventional conversation teaching material.

FIG. 2 shows an exemplary schematic view of a system for conversation practice in simulated situations, consistent with certain disclosed embodiments.

FIG. 3 shows an exemplary flowchart of a method for conversation practice in simulated situations, consistent with certain disclosed embodiments.

FIG. 4 shows an exemplar for explaining the conversation nodes and connection lines, consistent with certain disclosed embodiments.

FIG. 5 shows an exemplar for explaining the course objective rule and course objective tasks, consistent with certain disclosed embodiments.

FIG. 6 shows the features of multi-variation conversation sentences and multi-variation conversation flow for the situational conversation teaching material, consistent with certain disclosed embodiments.

FIG. 7 shows the feature of multi-variation conversation sentences for the situational conversation teaching material, consistent with certain disclosed embodiments.

FIGS. 8a-8g show the definition of the 8 types of connection lines in the multi-path connection rule, consistent with certain disclosed embodiments.

FIG. 9 shows an exemplary mapping table of biased sentences, consistent with certain disclosed embodiments.

FIG. 10 shows an exemplary schematic view of the structure and detailed operation of the audio processing module, consistent with certain disclosed embodiments.

FIG. 11 shows an exemplary schematic view of the structure and detailed operation of the conversation processing module, consistent with certain disclosed embodiments.

FIG. 12 shows an exemplar illustrating response pattern sentences for a sentence which is a learner's pronunciation error, consistent with certain disclosed embodiments.

FIG. 13 shows an exemplary schematic view of the structure of the output device, consistent with certain disclosed embodiments.

FIG. 14 shows a first working example of the situational conversation teaching material, consistent with certain disclosed embodiments.

FIG. 15 shows exemplary field tables for the variables based on FIG. 14 of the situational conversation teaching material, consistent with certain disclosed embodiments.

FIG. 16 shows a second working example of the situational conversation teaching material, consistent with certain disclosed embodiments.

FIG. 17 shows exemplary field tables for the variables based on FIG. 16 of the situational conversation teaching material, consistent with certain disclosed embodiments.

FIG. 18 shows a third working example of the situational conversation teaching material, consistent with certain disclosed embodiments.

FIG. 19 shows exemplary field tables for the variables based on FIG. 18 of the situational conversation teaching material, consistent with certain disclosed embodiments.

FIG. 20A shows an exemplar of adding biased error information to the situational conversation teaching material, where the result of the objective sentence is the sentence after variable processing, consistent with certain disclosed embodiments.

FIG. 20B shows an exemplary mapping table between the sentence after adding biased error information and the serial number of error type, consistent with certain disclosed embodiments.

FIG. 21 shows an exemplary mapping table of the synonymous sentence, consistent with certain disclosed embodiments.

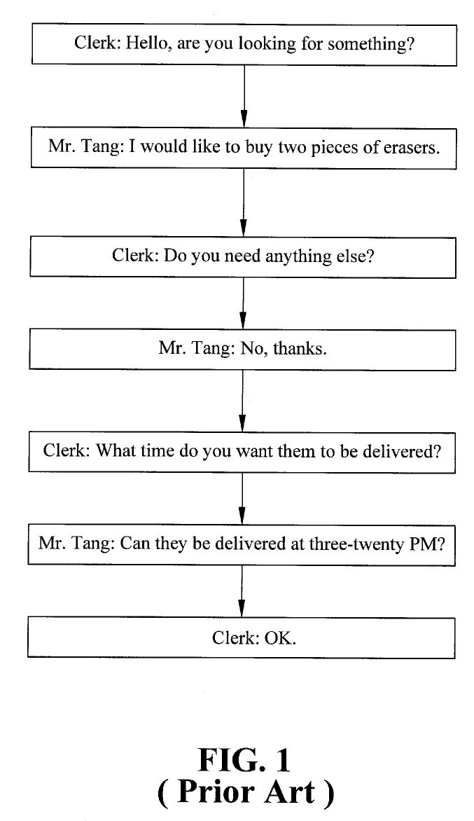

### DETAILED DESCRIPTION OF THE PREFERRED EMBODIMENTS

In actual world, the conversation between people is often face-to-face, and so is the language learning. When learning a kind of language, the learner usually hopes that the practice is with an actual person or an image of a person so that the contents of the conversation may have different responses based on the learner's different answers. In the disclosed exemplary embodiments, the system for conversation practice in simulated situations is based on the teaching material with multi-flow dialogue paths and dialogue sentences having a plurality of replaceable vocabulary items to provide the learner with interactive conversation practice. The system provides the learners with nature-like conversation environment to simulate the actual conversation situations. For example, the system provides a synthesized image of human face to simulate the face-to-face conversation, provides a plurality of sentence expressions of the same meaning to avoid the unalterable dialogue response, and provides multi-flow dialogue paths to avoid the unalterable dialogue flow.

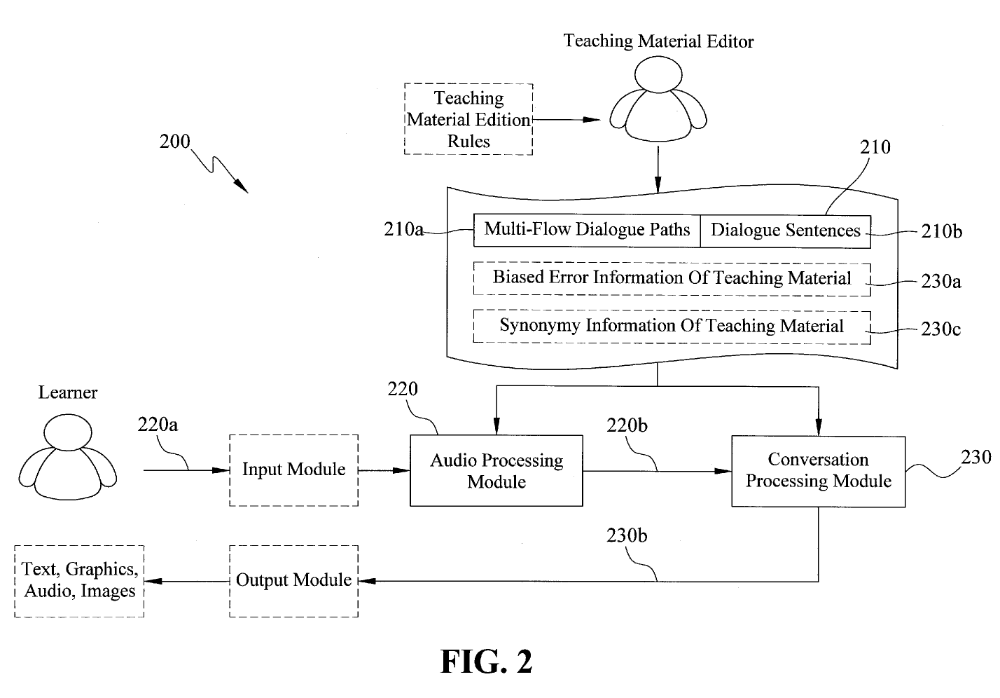

FIG. 2 shows an exemplary schematic view of a system for conversation practice in simulated situations, consistent with certain disclosed embodiments. Referring to FIG. 2, system 200 for conversation in simulated situations comprises a situational teaching material 210, consisting of multi-flow dialogue paths 210a and dialogue sentences 210b with a plurality of replaceable vocabulary items, an audio processing module 220 and a conversation processing module 230. Audio processing module 220 dynamically adjusts a speech recognition model according to different contents of the situational conversation teaching material 210, and recognizes an inputted audio signal 220a of the learners to determine and output information 220b on the recognition results to conversation processing module 230. Conversation processing module 230 determines information 230b in response to the learners, based on information 220b on the recognition results, situational conversation teaching material 210, wherein audio processing module 220 may dynamically adjust a speech recognition model based on different contents of situational conversation teaching material 210, and may further refers to biased error information 230a of the teaching material, synonymy information 230c of the teaching material, or any combination of the one or two of the above. Conversation processing module 230 may determine information 230b in response to the learner based on information 220b of the recognition result and situational conversation teaching material 210, and may further refer to biased error information 230a and synonymy information 230c of teaching material, or any combination of the one or two of the above, to determine information 230b in response to the learner.

The speech recognition model is selected from acoustic model, language model, grammar and dictionary. Audio processing module 220 may obtain audio signal 220a from the learner through an input module. Conversation processing module 230 may use an output module to output response information, such as text, graphics, audio or images. When the entire conversation practice is over, the output device may be used to output the conversation information of the learner so that the learner may understand the learner's own practice condition.

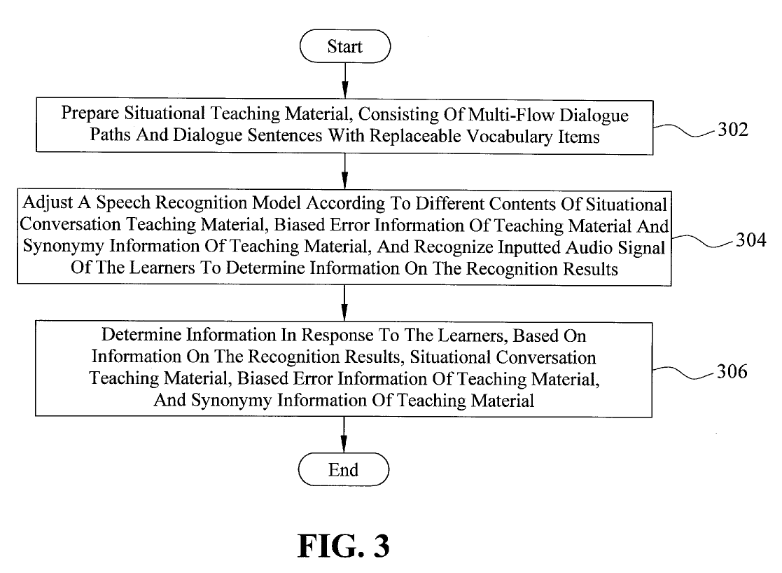

FIG. 3 shows an exemplary flowchart of a method for conversation practice in simulated situations, consistent with certain disclosed embodiments. Referring to FIG. 3, first, it is to prepare situational teaching material 210, consisting of multi-flow dialogue paths 210a and conversation sentences 210b with replaceable vocabulary items, as shown in step 302. The next step 304 is to adjust a speech recognition model according to different contents of situational conversation teaching material 210, biased error information 230a of the teaching material, and synonymy information 230c of the teaching material, and recognize inputted audio signal 220a of the learners to determine information 220b on the recognition results. In step 306, it is to determine information 230b in response to the learners, based on information 220b on the recognition results, situational conversation teaching material 210, biased error information 230a of the teaching material, and synonymy information 230c of the teaching material.

The situational conversation teaching material is generated according to the edition rules of teaching material. The situational conversation teaching material may also includes a database of biased errors. The data in the bias database, called biased error information 230a, is generated according to the common errors and the teaching material, and may be used by conversation processing module 230 as reference information in determining the correctness of the conversation dialogues used by the learner. The situational conversation teaching material may also include a synonymy database. The data in synonymy database, called synonymy information 230c, is generated according to the common expressions and vocabulary analysis, and may be used by conversation processing module 230 as a reference in analyzing the synonymy used by the learner so as to dynamically adjust the speech recognition model and recognize the inputted audio signals of the learner.

Another exemplary flowchart of the method for conversation practice in simulated situations is to simplify the flow of FIG. 3. The first step is to prepare situational teaching material 210, consisting of multi-flow dialogue paths 210a and conversation sentences 210b with replaceable vocabulary items, as shown in step 302. The simplified step 304 is to adjust a speech recognition model according to situational conversation teaching material 210, and recognize inputted audio signal 220a of the learners to determine information 220b on the recognition results. Based on information 220b on the recognition results and situational conversation teaching material 210, the response information 230b to the learner may be determined.

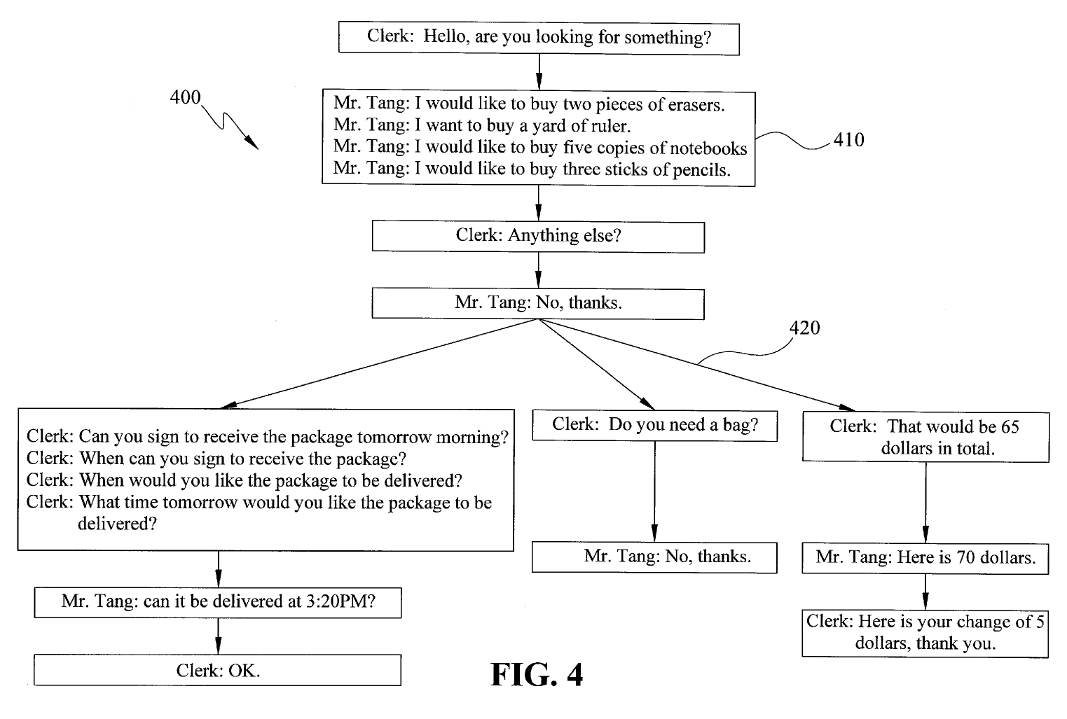

In the disclosed embodiments, each conversation node for the situational conversation teaching material is directionally connected by the node connection lines. FIG. 4 shows an exemplar for illustrating the conversation node and connection lines, consistent with certain disclosed embodiments. As shown in FIG. 4, mark 410 is a conversation node of a general teaching material 400, and the conversation nodes are directionally connected by node connection line 420.

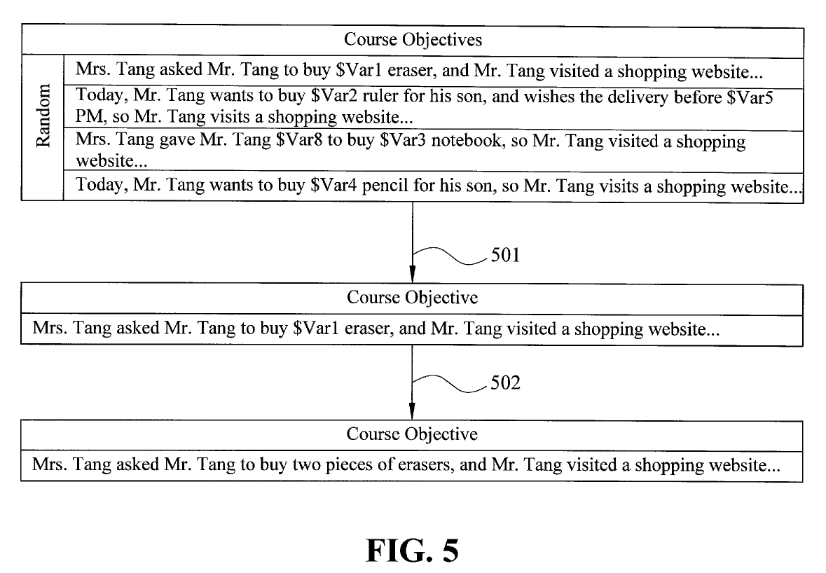

The edition rules of teaching material may include the course objective rules, multi-path connection rules, multi-variation conversation sentence rules, and so on. The course objective rules, as shown in FIG. 5, shows that each course may have a plurality of course objectives, and each course objective may include one or more variables. However, the course objectives describes the required tasks that must be accomplished for each course and the tasks of the course will be a course objective, marked as 501, randomly selected from all of the objectives of the course. Then, the variable in the course objective is replaced to become the task of this learning, marked as 502. The designed conversation sentences and the conversation flows will be appropriately arranged targeting the current course objective. When the learner finishes the current course, the accomplishment extent of the course objective after this practice will be shown to understand whether or not the course objective is accomplished in this learning session.

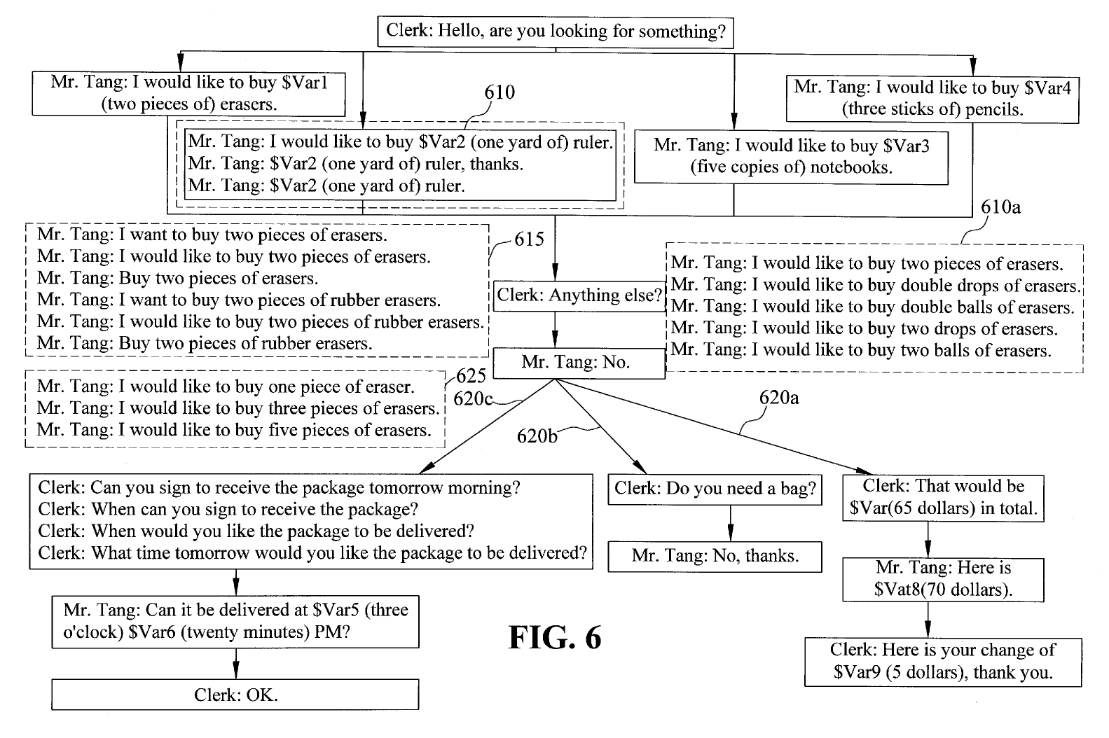

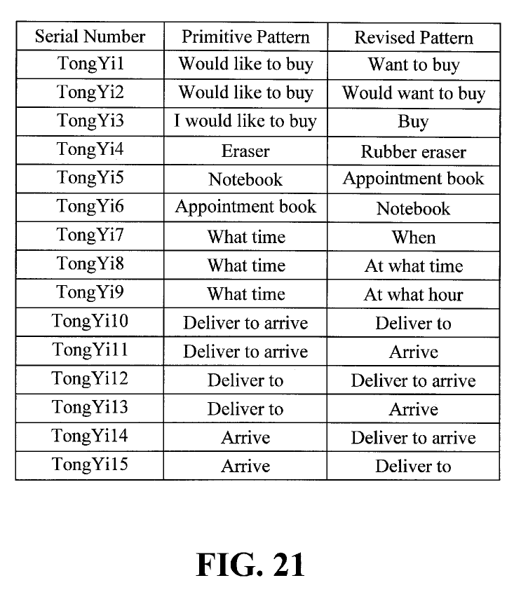

With the example of FIG. 4, FIG. 6 further shows the features of multi-variation conversation sentences and multi-variation conversation flow for the situational conversation teaching material, consistent with certain disclosed embodiments. As shown in FIG. 6, the sentences of the course objective may include plural variations, such as, multi-variation sentence 610, and many variables. Take the sentence “I would like to buy $Var1 (two pieces of) erasers” as an example. Assume that $Var1 randomly selects “two pieces of”. So the complete sentence will be “I would like to buy two pieces of erasers.” According to the primitive patterns and revised patterns in FIG. 21, “would like to” may be replaced by “want to buy” or “buy”. The synonymous sentence “I would like to buy two pieces of erasers.” may be replaced by “I want to buy two pieces of erasers.” or “Buy two pieces of erasers.”; moreover, “eraser” and “rubber eraser” are synonyms too. Hence, “I want to buy two pieces of rubber erasers”, “I would like to buy two pieces of rubber erasers” and “buy two pieces of rubber erasers.” may all be shown in synonymous sentence 615 of multi-variation sentence 610. If variable $Var1 randomly selects “one piece of”, the synonymous sentences are changed to “I want to buy one piece of eraser”, “I want to buy one piece of rubber eraser”, “I would like to buy one piece of eraser”, “I would like to buy one piece of rubber eraser”, “buy one piece of eraser”, and “buy one piece of rubber eraser.”

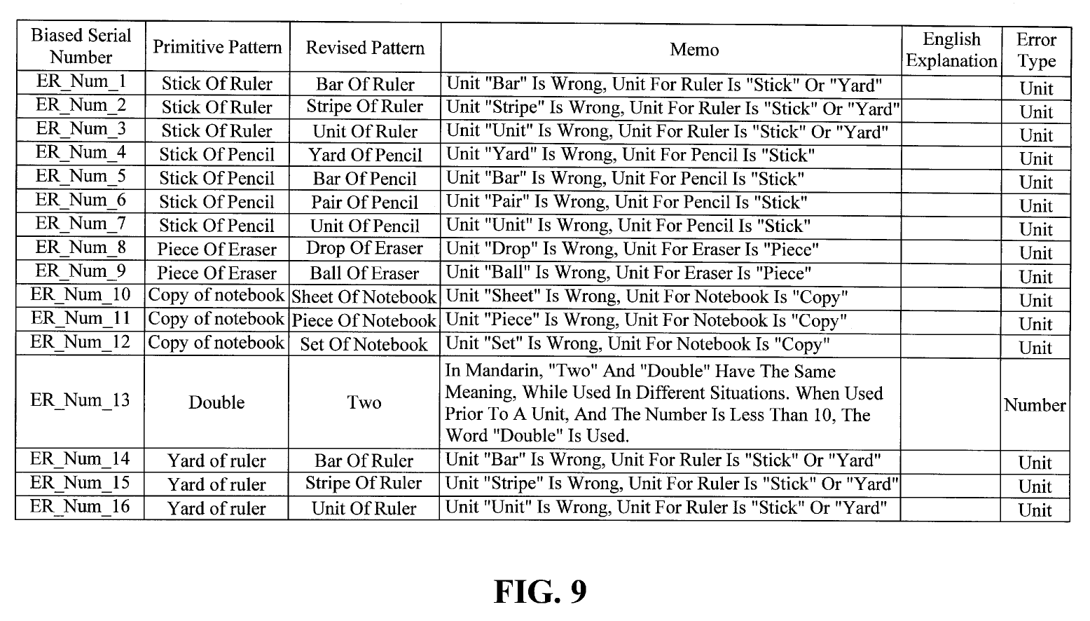

This example also includes biased error information. According to the primitive pattern and revised pattern which are made by teachers shown in FIG. 9, for example, it's a biased error information for foreigners learning mandarin, “two” (liang3) can be mistaken for “double” (er4). The sentence “I would like to buy two pieces of erasers.” (wo3 xiang3 yao4 mai3 liang3 kuai4 xiang4 pi2 ca1) will be changed to “I would like to buy double pieces of erasers.” (wo3 xiang3 yao4 mai3 er4 kuai4 xiang4 pi2 ca1). “piece of eraser” (kuai4 xiang4 pi2 ca1) can be mistaken for “drop of eraser” (li4 xiang4 pi2 ca1) or “ball of eraser” (ke1 xiang4 pi2 ca1). The sentence also can be changed to “I would like to buy two drops of erasers” (wo3 xiang3 yao4 mai3 liang3 li4 xiang4 pi2 ca1), I would like to buy two balls of erasers” (wo3 xiang3 yao4 mai3 liang3 ke1 xiang4 pi2 ca1), “I would like to buy double drops of erasers” (wo3 xiang3 yao4 mai3 er4 li4 xiang4 pi2 ca1), I would like to buy double balls of erasers.” (wo3 xiang3 yao4 mai3 er4 ke1 xiang4 pi2 ca1). All of above biased sentences may be shown in 610a of multi-variation sentence 610.

In learning different language, the disclosure provides rules to handle “biased sentences”. The following is another disclosed English embodiment of the disclosure. In the instance of “He is girl”, it includes two biased error information, lack of “a” and “girl” with corresponding “She”. Therefore it would be handled as “She is a girl”.

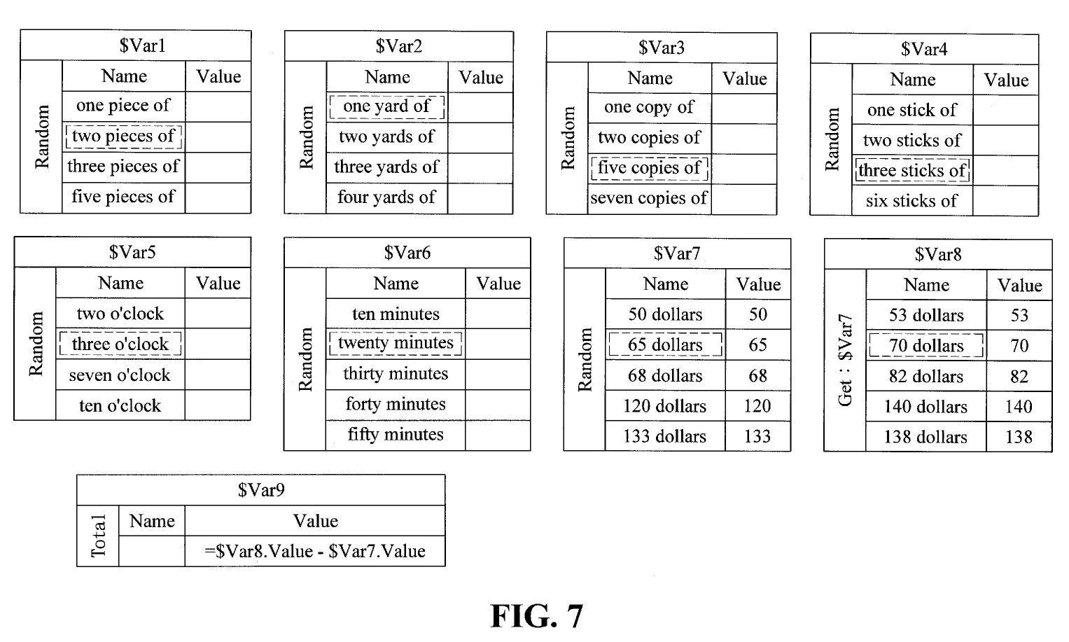

The disclosure is also designed for supporting “mistake sentences”, defined as the mistakes that the learners should have noticed, but not. For an example according “I would like to buy $Var1 erasers.”, $Var1 is selected as “two pieces of” randomly. The mistake sentences of the above example will be generated by using the other names in the $Var1 tables in FIG. 7. Three mistake sentences generated are “I would like to buy one piece of erase”, “I would like to buy three pieces of erasers” and “I would like to buy five pieces of erasers”, shown as mark 625 in FIG. 6.

In this exemplar of situation conversation teaching material, the total number of variables of the course objective sentences is nine, i.e., $Var1-$Var9, as shown in FIG. 7. FIG. 7 shows the feature of multi-variation conversation sentences for the situational conversation teaching material, consistent with certain disclosed embodiments. Variables $Var1-Var9 have three attributes and two data fields. The three attributes are Random, Get and Total, and the two data fields are Name and Value. The following describe the features of the three attributes.

Attribute Random is the most common attribute used in the course production. The function of Random is to perform random selection for variable with attribute Random after the leaner enters the course. Attribute Get is for the highly related variables. The function is to let the variable with attribute Get has the same random reference value as the variable to be got. For example, variable $Var7 is for total amount and variable $Var8 is for the pay amount. The pay amount must be always greater than or equal to the total amount; otherwise, the conversation flow will confuse the learner. The use of attribute Get follows the logic of the teaching material editor, and may be used for different purposes, such as the mapping between unit (stick, yard, copy) and noun (pencil, ruler, book). The mapping may also be solved by the use of this attribute. Attribute Total is for simple calculation, such as change, sum, to provide the basic arithmetic calculation.

The multi-variation conversation flow, shown as marks 620a-620c of FIG. 6, has three different conversation flows. The conversation sentences and conversation flows are also arranged appropriately according to the course objective. For example, when the course objective selects the sentence “Today, Mr. Tang wants to buy his son $Var2 (two yards of) rulers and wishes to deliver by $Var5 (three o'clock) PM. So Mr. Tang visits shopping website . . . ”, the system will remind the learner of the course objective in the practice so that the learner will not get lost during the conversation. Also, after each dialogue, the accomplishment extent of the current course objective is updated in real time. After the conversation, the leaner will be informed whether the course objective is accomplished in this practice.

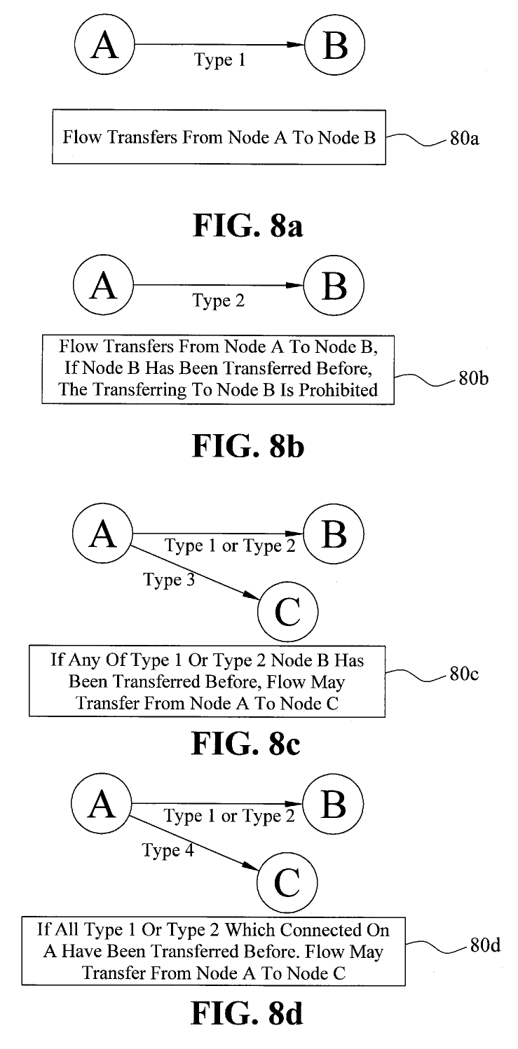

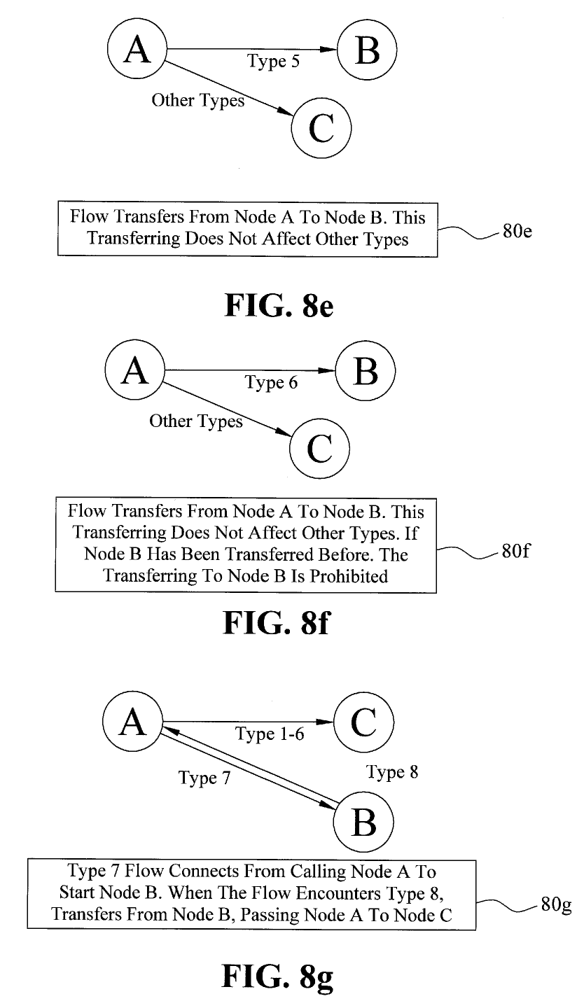

The multi-path connection rule defines 8 types of connection lines for conversation nodes, called Type 1-8 connection lines. FIGS. 8a-8g show the definition of Type 1-8 connection lines of the multi-path connection rule.

Refer to FIG. 8a. Type 1 connection line represents the flow transferring from conversation node A to conversation node B, shown as marked 80a. The connection line is a basic connection line and conversation node B connected by the connection line can be transferred to repeatedly.

Refer to FIG. 8b. Type 2 connection line represents the flow transferring from conversation node A to conversation node B, and if conversation node B has been transferred to before, then transferring to conversation node B is prohibited, shown as marked 80b. In other words, the connection line is a basic connection line and conversation node B connected by the connection line cannot be transferred to repeatedly.

Refer to FIG. 8c. Type 3 connection line represents that if a conversation node connected to conversation node A, such as conversation node B, of Type 1 and Type 2 connection lines have been transferred to before, the flow will be transferring from conversation node A to conversation node C, shown as marked 80c. In other words, after either Type 1 or Type 2 connection line which connected on the node has been transferred once, the node of the Type 3 connection line can be taken.

Refer to FIG. 8d. Type 4 connection line represents that if all the conversation nodes connected to conversation node A by Type 1 and Type 2 connection lines have been transferred to before, the flow will be transferring from conversation node A to conversation node C, shown as marked 80d. In other words, after all the Type 1 or Type 2 connection lines which connected on the node have been transferred once, the node of the Type 4 connection line can be taken.

Refer to FIG. 8e. Type 5 connection line represents the flow transferring from conversation node A to conversation node B, and the transferring will not affect other types, shown as marked 80e. In other words, the connection line is not a basic connection line and conversation node B connected by the connection line can be transferred to repeatedly.

Refer to FIG. 8f. Type 6 connection line represents the flow transferring from conversation node A to conversation node B, and the transferring will not affect other types. If conversation node B has been transferred to before, transferring to conversation node B is prohibited, shown as marked 80f. In other words, the connection line is not a basic connection line and conversation node B connected by the connection line cannot be transferred to repeatedly.

Refer to FIG. 8g. Type 7 connection line, i.e., the Call connection line, represents the flow connecting from conversation node A (calling node) to conversation node B (starting node). When the flow encounters Type 8 connection line, i.e., the Return connection line, the flow will transfer from conversation node B, passing node A and to node C, shown as marked 80g. In other words, Type 8 connection line is a connection line returning from starting node to calling node.

Multi-variation conversation sentence rules allow a plurality of sentences with the same meaning and yet different expressions to exist in a conversation node so as to increase the situational effect matching the actuality. In addition, variable assignment function can be assigned to different conversation sentences, such as numeric variable, string variable, and providing calculation equations between variables. The course may be more vivid and lively according to the assignment by the teaching material editor. Hence, system 200 for conversation practice in simulated situations has the function of allowing situational conversation teaching material 210 to set course objectives.

Bias database of teaching material is obtained by collecting the common biased errors made by the learners and analyzed by professional scholars. The bias database points out the correspondence between the correct sentences and vocabulary versus the erroneous sentences and vocabulary, which may be shown as a mapping table in FIG. 9. The biased serial number field records the type and the serial number of the bias, such as ER_Num_11. The primitive pattern field records the pattern edited by the course editor, usually about the correct usage of the language. For example, ER_Num_11 corresponds to primitive pattern “copy of notebook”. The revised pattern field records the possible error or other usages of the primitive pattern. For example, ER_Num_11 correspond to revised pattern “piece of notebook”. The memo field records the explanation of the rules for reference by the editor. For example, ER_Num_11 corresponds to memo: unit “piece” an error, unit for notebook being “copy”. The English memo field records the English description of the rules, which may be changed to the native language of the learner to help the learner to understand the correct use for the erroneous sentence and future reference. Error type field records the type of the bias to which the rule belongs to.

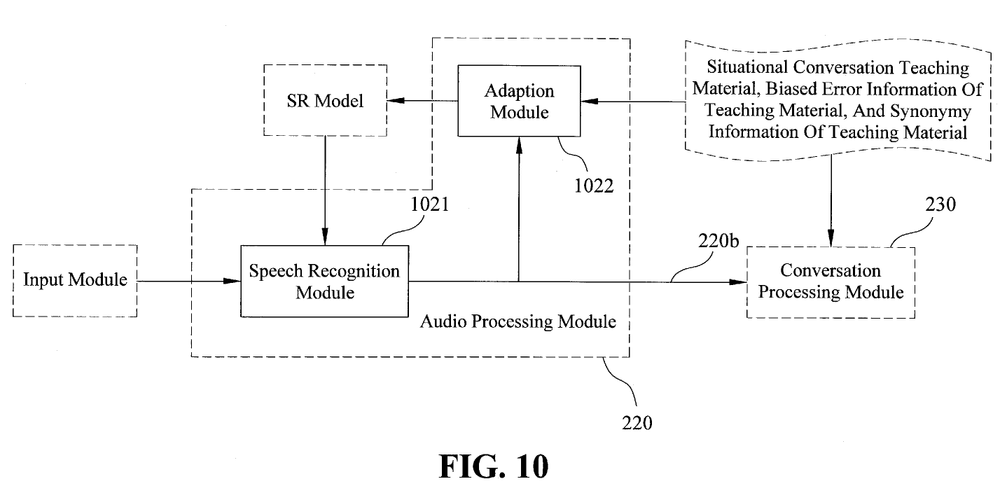

Audio processing module 220 may obtain the leaner's audio signal through an input module, and perform the speech recognition and voice adaption to determine the information in response to the conversation processing module. FIG. 10 shows an exemplary schematic view of the structure and detailed operation of the audio processing module 220, consistent with certain disclosed embodiments. Referring to FIG. 10, audio processing module 220 comprises a speech recognition module 1021 and an adaption module 1022. According to the situational conversation teaching material, biased error information of teaching material and synonymy information of teaching material, adaption module 1022 dynamically adjusts the speech recognition model in provision to speech recognition module 1021 for recognizing the learner's audio signals. Adaption module 1022 also adjusts the acoustic model of the speech recognition model according to the learner's audio signal for voice adaption, and adjusts the language model, grammar and dictionary to improve the speech recognition according to the situational conversation teaching material, biased error information of teaching material and synonymy information of teaching material. Speech recognition module 1021 transmits information 220b of the recognition results to conversation processing module 230 in order to perform corresponding response. The information of the recognition results may be, for example, sentence grade or sentence text.

According to the above, step 304 of FIG. 3 may include the following sub-steps: according to the situational conversation teaching material, biased error information of teaching material and synonymy information of teaching material, dynamically adjusting the speech recognition model for performing speech recognition on the learner's audio signals; according to the learner's audio signals, performing voice adaption, and according to the situational conversation teaching material and biased error information of teaching material, adjusting acoustic model of the speech recognition model, and adding synonymy information of teaching material to adjust the language model, grammar and dictionary in the speech recognition model for improving the speech recognition; and then determining and outputting the recognition results of the learner's audio signal. In another exemplar, the speech recognition model may be directly dynamically adjusted according to the situational conversation teaching material. Alternatively, the speech recognition model may be dynamically adjusted according to the situational conversation teaching material and the biased error information of teaching material. Or, the speech recognition model may be dynamically adjusted according to the situational conversation teaching material and synonymy information of teaching material.

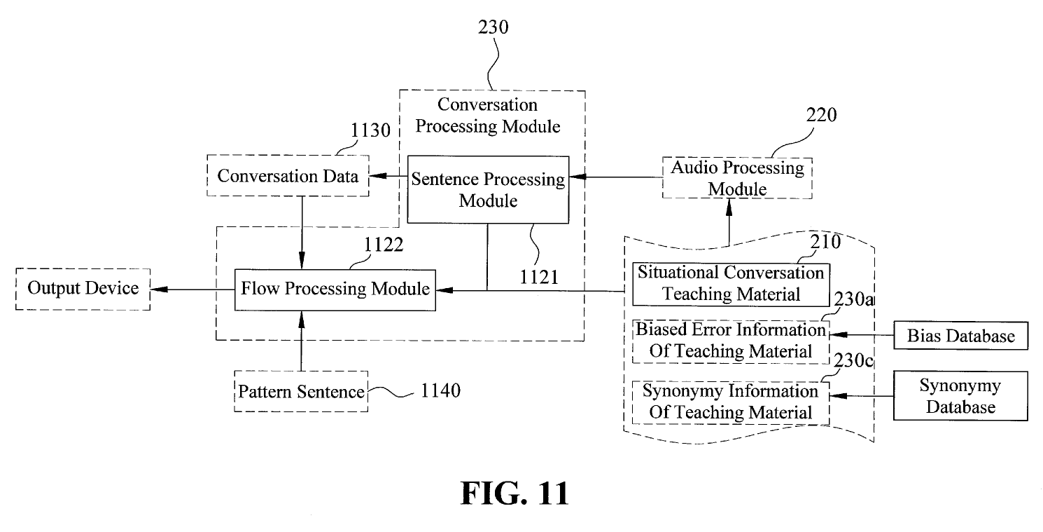

Conversation processing module 230 may detect the possible errors of the grammar and pronunciation according to the recognition results and biased error information, and determine the information in response to the learner according to the situational conversation teaching material. The learner's conversation practice record may also be stored. The conversation practice record may include the conversation sentences, intonation, pronunciation and bias. FIG. 11 shows an exemplary schematic view of the structure and detailed operation of the conversation processing module, consistent with certain disclosed embodiments. The detailed operation is also the sub-steps of step 306 of FIG. 3.

As shown in FIG. 11, conversation processing module 230 comprises a sentence processing module 1121 and a flow processing module 1122. According to the information of audio processing module 220 (including situational conversation teaching material 210, or situational conversation teaching material 210 plus biased error information 230a and synonymy information 230c of teaching material) and the information of the speech recognition results, sentence processing module 1121 determines whether the conversation sentence of the learner is correct, synonymous, biased or mispronouncing, and records the related information of the conversation sentence to conversation data 1130. Biased error information of teaching material 230a may be information in a database of biased errors, and synonymy information of teaching material 230c may be information in a database of synonyms. When the information of audio processing module 220 includes situational conversation teaching material 210 plus biased error information 230a or synonymy information 230c of teaching material, sentence processing module 1121 may provide the information on whether the learner's sentence is synonymous, biased or mispronouncing according to the information of audio processing module 220 and the information of recognition results.

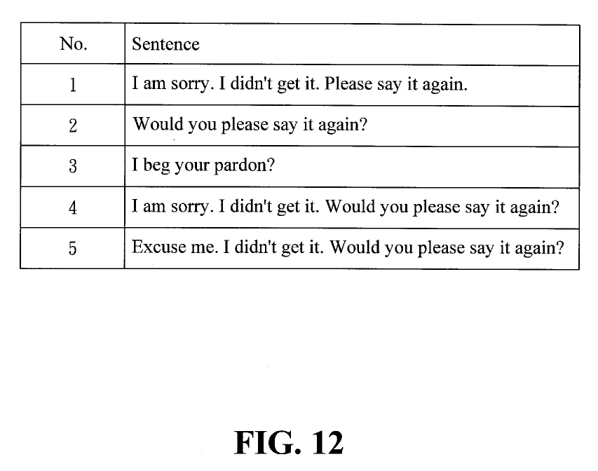

According to the determination of sentence processing module 1121, flow processing module 1122 determines the response sentence. If the determination is the conversation sentence of the learner is correct, synonymous or biased, flow processing module 1122 will continue the conversation in the next conversation node of the teaching material. If the determination is the conversation sentence of the learner is mispronouncing, flow processing module 1122 will continue the conversation in pattern sentence 1140 as response. Pattern sentence 1140 is the conversation sentence in response to the learner when the leaner's sentence is determined to be mispronouncing, as shown in FIG. 12.

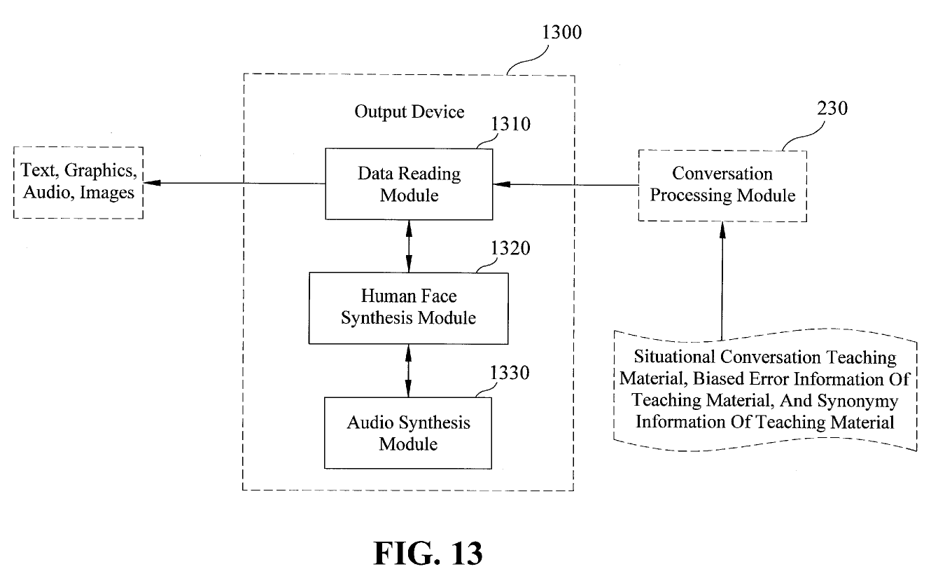

If the learner's sentence in that conversation node is determined to be mispronouncing again, the flow may be set to continue the conversation sentence in the next conversation node. When executing the next conversation sentence, an output device may be used to output the information of the required response, such as text, graphics, audio, image, and so on. FIG. 13 shows an exemplary schematic view of the structure of the output device, consistent with certain disclosed embodiments. When the entire conversation practice is over, an output device may be used to show the conversation data so that the learner may understand his/her own practice situation.

As shown in FIG. 13, output device 1300 may include a data reading module 1310, or an image-based human face synthesis module 1320, or an audio synthesis module 1330. Data reading module 1310 may receive and display the output data from conversation processing module 230. If the received data is text or audio, image-based human face synthesis module 1320 may be used to generate a human face and an integrated audiovisual may be outputted, or audio synthesis module 1330 may be used to synthesize the text data into audio for output.

The following shows three working examples to describe the flow of the situational conversation teaching material, Type 1-8 connection lines of multi-path connection rules and the design of situational conversation teaching material.

In the first working example, the course objective is that Mr. Tang would like to buy three red pens, three bottles of ink, and notebook at a shopping website. Through situational conversation teaching material 210, the course objective may be set as “Mr. Tang would like to buy $Var1 (3) $Var2 (red) pens, $Var7 (3) $Var4 (bottles of ink) and $Var3 (notebook).” In other words, system 200 for conversation practice in simulated situations allows the function of setting course objective.

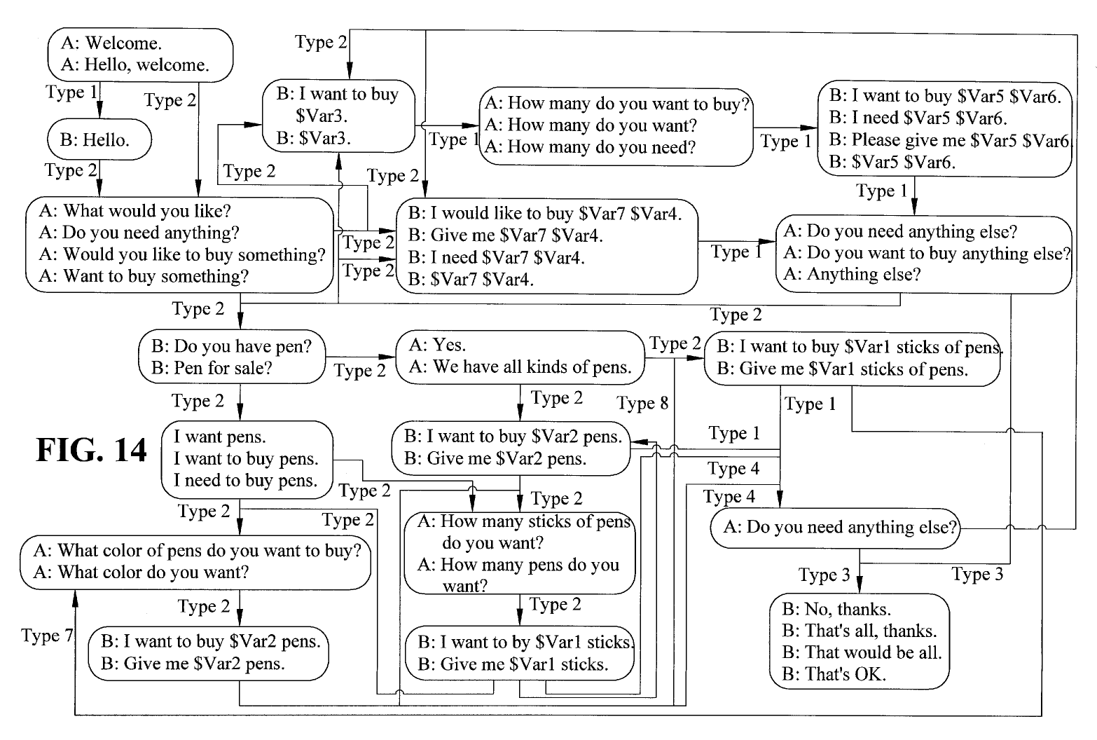

According to the aforementioned defined 8 types of connection lines, an exemplary flow of the situational conversation teaching material may be generated in FIG. 14. In the exemplary flow, according to the multi-path connection rules, the flow passes may include Type 1 connection line, Type 2 connection line, Type 3 connection line, Type 4 connection line, Type 7 connection line, and Type 8 connection line.

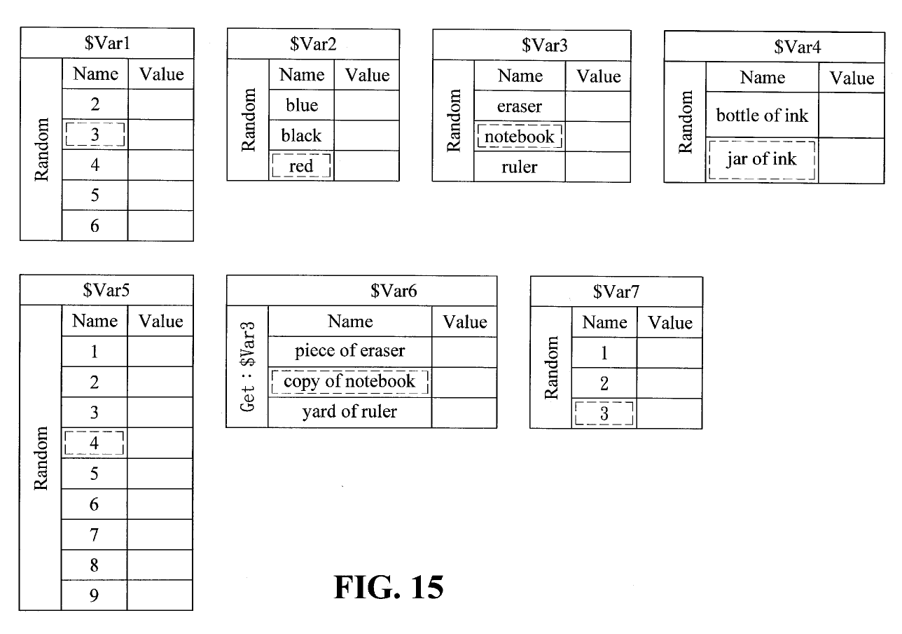

As seen in the exemplary flow of FIG. 14, the conversation script of the situational conversation teaching material at least includes the design of conversation node, conversation flow, conversation sentence, synonymous sentence, biased sentence, and mistake sentence. The conversation data also requires, for example, variable table, for recording. FIG. 15 shows an exemplary field tables for the variables based on FIG. 14 of the situational conversation teaching material, consistent with certain disclosed embodiments.

There are seven variable field tables in the exemplar of FIG. 15, $Var1-$Var7. Variable field $Var1 is a string variable for recording the possible number of pens, such as 2, 3, 4, 5, 6. Variable field $Var2 is a string variable for recording the possible color of pens, such as, blue, black, red. Variable field $Var7 is a string variable for recording the possible number of bottles of ink, such as, 1, 2, 3. Variable field $Var6 uses attribute Get to obtain the random reference value the same as variable field $Var3. In this exemplar, the randomly selected values for each variable field are: $Var1=“3”, $Var2=“red”, $Var3=“notebook”, $Var4=“bottles of ink”, $Var5=“4”, $Var6=“copies of notebooks”, and $Var7=“3”.

As seen in FIGS. 14-15, a conversation node may include sentences with same meaning but of different expressions. Also, different conversation sentences may have different variable setting functions, such as numeric variables, string variables, and collaborative use of variables. Situational conversation teaching material 210 also allows the functions of sharing the same variable name between course objective and the sentence in conversation node. Hence, the course may be more vivid and lively and create situations effect matching actuality.

In the second working example, the course objective is that Mr. Tang would like to buy two red pens, and one pack of brown paper at a shopping website. If the red pens are sold out, two blue pens will do. Through situational conversation teaching material 210, the course objective may be set as “Mr. Tang would like to buy $Var1 (two sticks of) $Var2 (red pens), if $Var2 (red pens) are sold out, $Var1 (two sticks of) !$Var2 (blue pens) will do, and $Var3 (one pack of) $Var4 (brown paper). It is worth noting another feature of the multi-variation conversation sentence. The difference between $Var2 (red pens) and !$var2 (blue pens) is the “!” symbol indicating the variable with attribute Random to deduct the current selection when randomly selecting a reference value again. For example, $Var2 randomly selects “red pens”, and then !$Var2 will randomly select from “blue pens” and “black pens” but “red pens”.

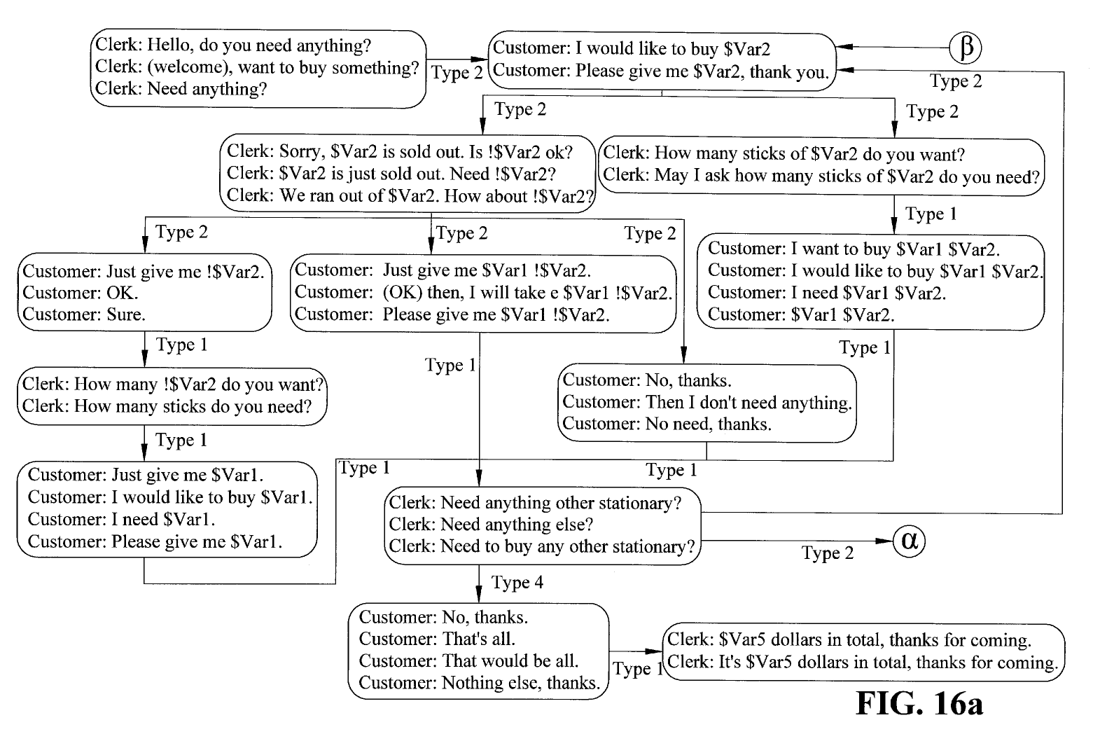

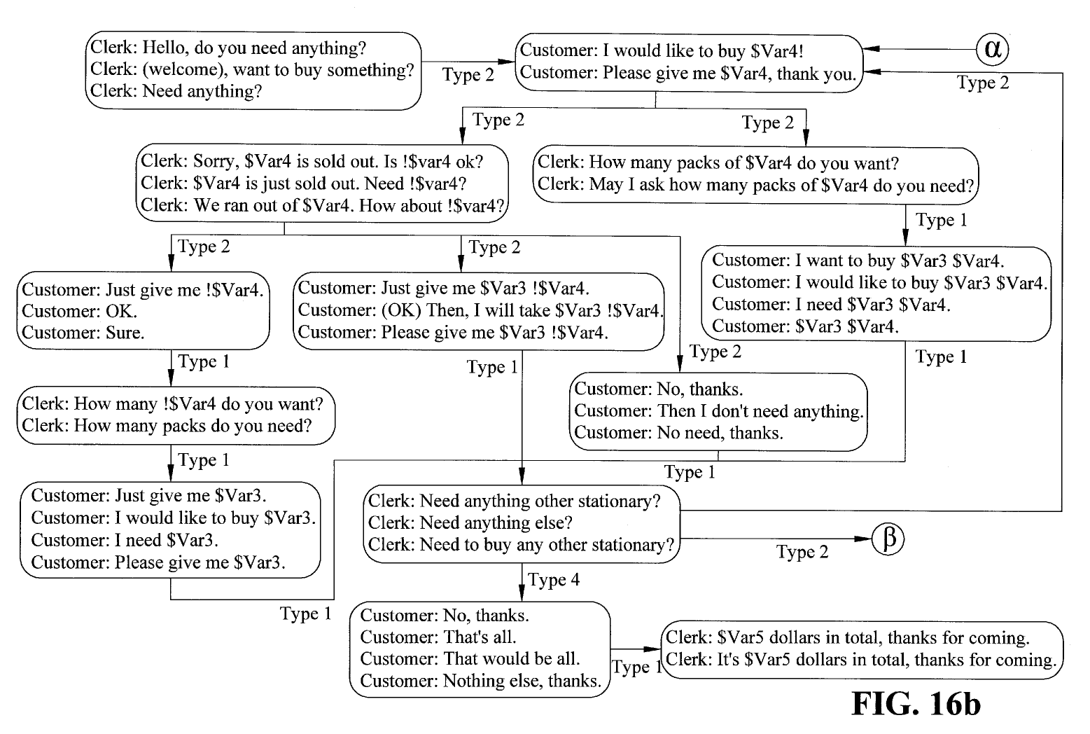

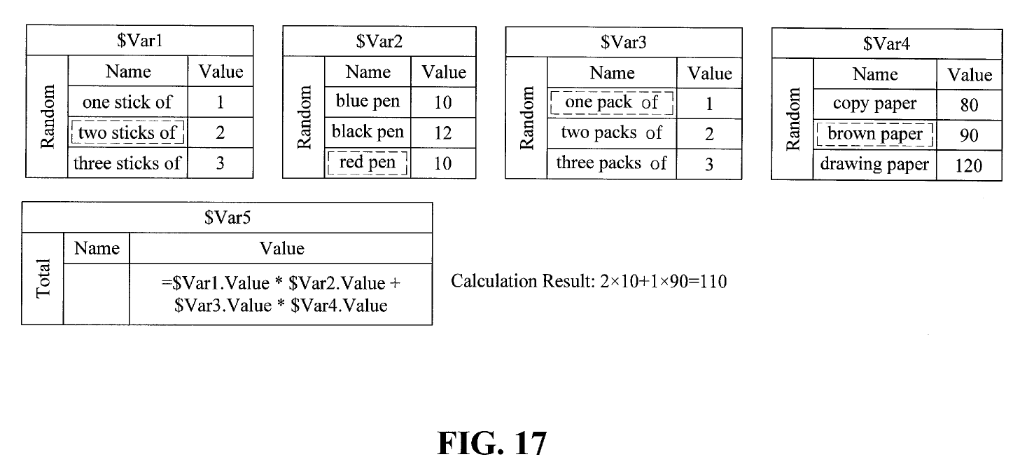

According to the aforementioned defined 8 types of connection lines, an exemplary flow of the situational conversation teaching material may be generated in FIG. 16. In the exemplary flow, according to the multi-path connection rules, the flow passes may include Type 1 connection line, Type 2 connection line, and Type 4 connection line. FIG. 17 shows exemplary field tables for the variables based on FIG. 16 of the situational conversation teaching material, consistent with certain disclosed embodiments.

As seen in FIG. 17, the calculation equation between variables, such as $Var5 having an attribute Total, and the numeric variable is equal to $Var1.Value*$Var2.Value+$Var3.Value*$Var4.Value. When the randomly selected fields are “two red pens+a pack of brown paper”, the result of the calculation is 2×10+1×90=110. Therefore, system 200 for conversation practice in simulated situations provides the calculation equations between variables. In addition, $!Var2 may select “blue pens” after deducting the last random selection, and $!var4 may selects “drawing paper”. In this manner, the conversation sentences may vary because vocabulary may be replaced. Therefore, system 200 may raise the learner's interest through various simulated situations.

In the third working example, the course objective is that Mr. Tang would like to buy four yards of rulers, five sticks of pens, seven copies notebooks and three pieces of erasers at a shopping website, and wishes the items may be delivered to his house by two o'clock. In addition, Mr. Tang's son would like to buy a sport item if Mr. Tang sees any. Through situational conversation teaching material 210, the course objective may be set as “Mr. Tang would like to buy $T1 (four yards of) rulers, $T2 (five sticks of) pens, $T3 (seven copies of) notebooks and $T4 (three pieces of) erasers, and wishes the items to be delivered by $T5 (two) o'clock. In addition, Mr. Tang's son would like to buy a sport item if Mr. Tang sees any.”

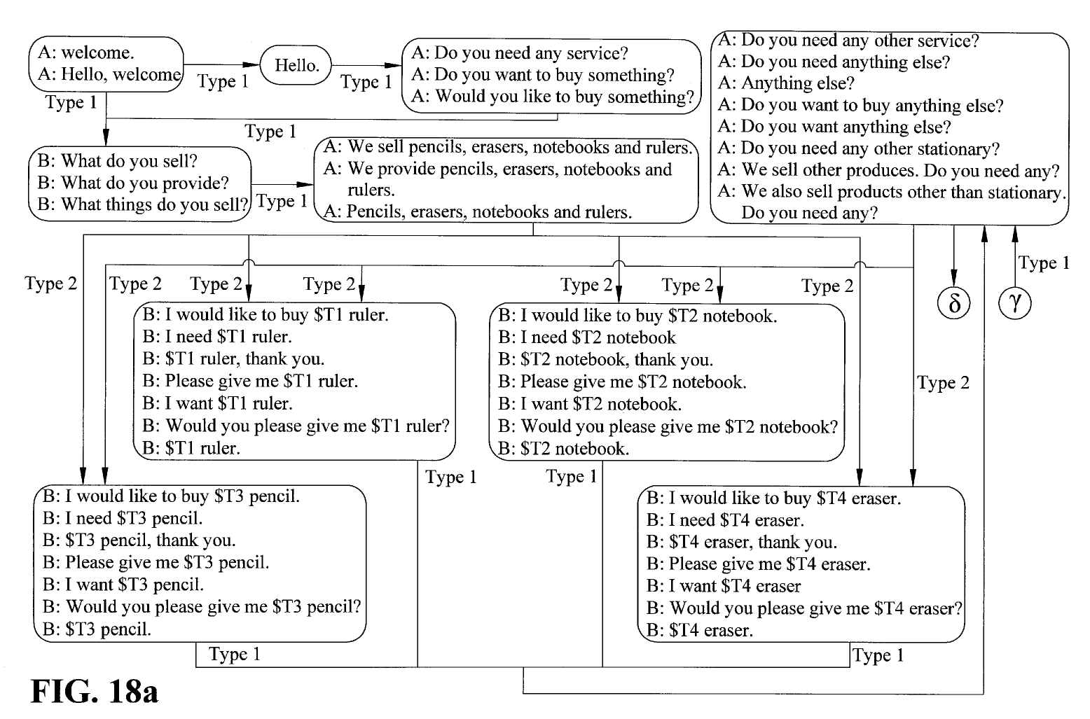

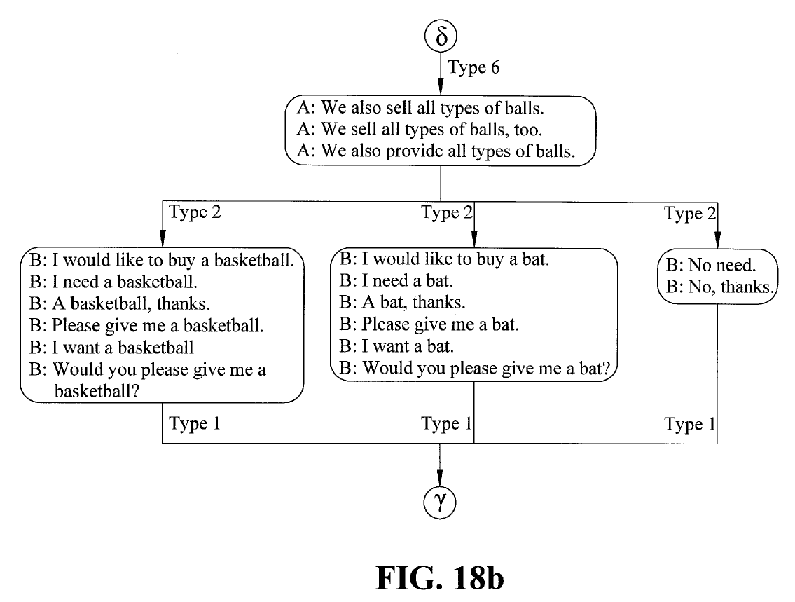

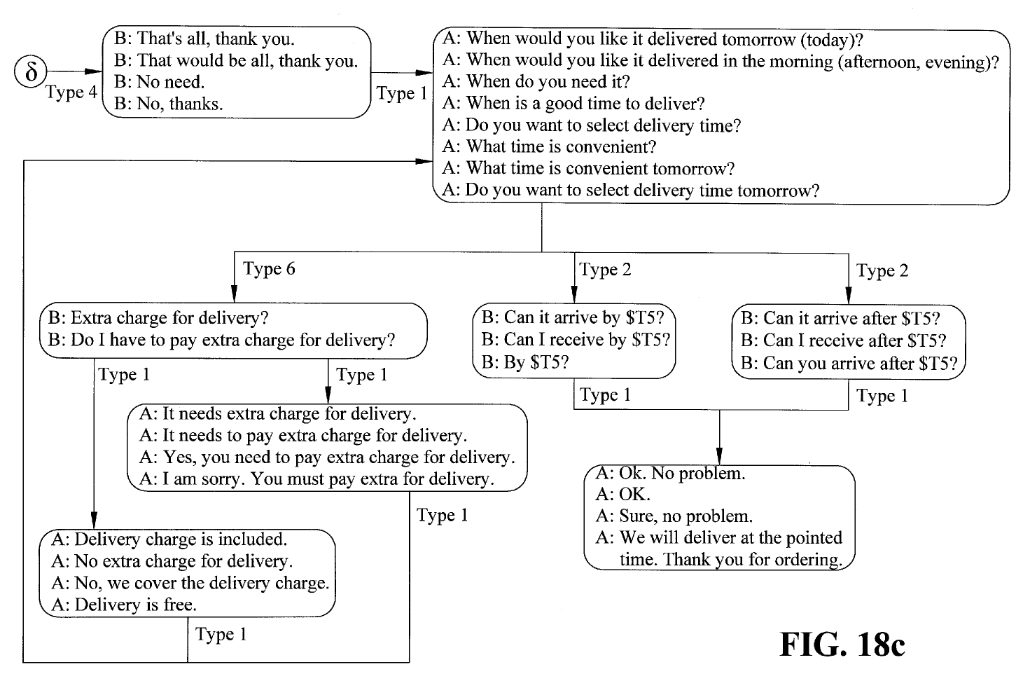

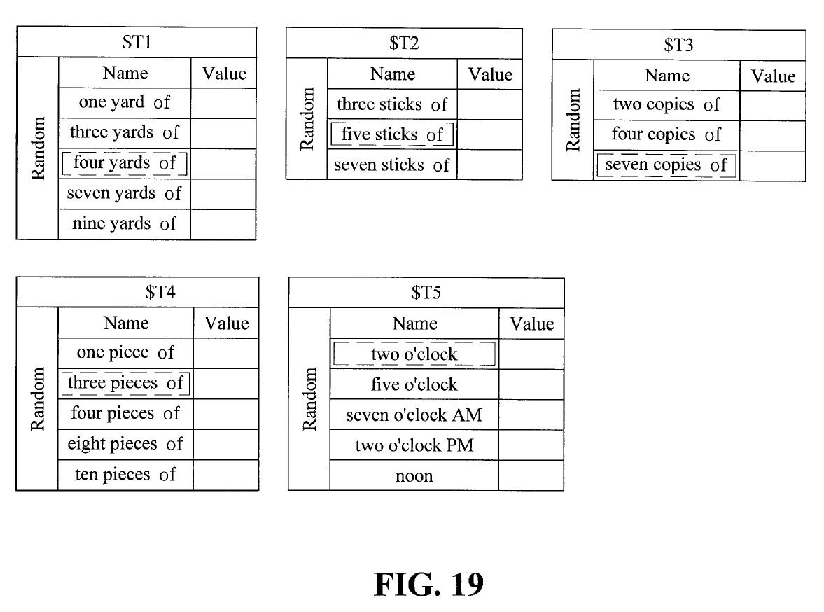

According to the aforementioned defined 8 types of connection lines, an exemplary flow of the situational conversation teaching material may be generated in FIG. 18. In the exemplary flow, according to the multi-path connection rules, the flow passes may include Type 1 connection line, Type 2 connection line, Type 4 connection line, and Type 6 connection line. FIG. 19 shows exemplary field tables for the variables based on FIG. 18 of the situational conversation teaching material, consistent with certain disclosed embodiments.

There are five variable field tables in the exemplar of FIG. 19, $T1-$T5. Variable fields $T1-$T5 are all string variables, for example, $T1 records the number and the unit of the ruler, such as, one yard of, three yards of, four yards of, seven yards of, nine yards of. $T2 records the number and the unit of the pen, such as, three sticks of, five sticks of, seven sticks of. $T5 records the time for item delivery, using hours as the unit.

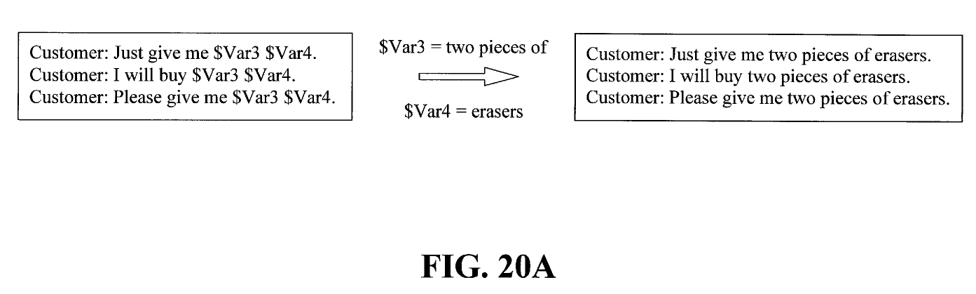

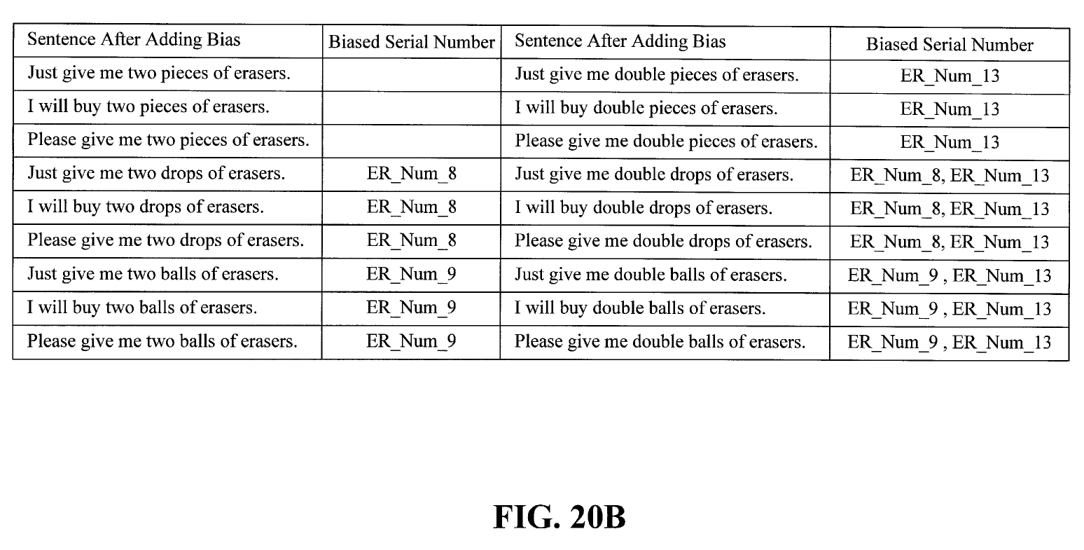

FIGS. 20A-B show an exemplar of adding biased error information to the situational conversation teaching material, biased error information, and the result of the exemplar is the objective sentence plus biased sentence, consistent with certain disclosed embodiments. According to the teaching material editor input sentence in the tables in FIG. 20A, the system performs the replacement and refers to FIG. 9 to replace the replaced sentence with the primitive pattern and revised pattern to find the corresponding error type serial number to generate FIG. 20B. The biased serial number in FIG. 20B may refer to note field in FIG. 9 to provide the explanation and correct usage for the biased error sentence to the learner.

In summary, the disclosed embodiments may provide a system and method for conversation practice in simulated situations. The teaching material editor may use the disclosure to design the situational conversation teaching material with multi-variation conversation sentences and multi-variation conversations flows. Each conversation teaching material may be set with conversation objectives and replaceable vocabulary of the conversation sentences so that the conversation sentence may include different variations, while the conversation flow also depends on the learner's response. With the system of conversation practice in simulated situations, the learner may interact with the synthesized human face in a simulated situation. When the learner makes a biased error, the information may be recorded and displayed after finishing the conversation practice. The errors made by the learner may be pointed out.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for conversation practice in simulated situations, comprising:
a situational conversation teaching material with multi-flow dialogue paths and dialogue sentences having a plurality of replaceable vocabulary items;
an audio processing module for dynamically adjusting a speech recognition model according to different contents of said situational conversation teaching material, and recognizing inputted audio signal of a learner to determine information on recognition results; and
a conversation processing module for determining information in response to said learner, according to information on said recognition results and said situational conversation teaching material.

2. The system as claimed in claim 1, wherein said situational conversation teaching material further includes a bias database of teaching material and a synonymy database of teaching material, said bias database includes biased error information obtained by collecting and analyzing learners' common errors and said synonymy database includes synonymy information obtained by collecting and analyzing synonymous common expression and vocabulary.

3. The system as claimed in claim 1, wherein said audio processing module further includes synonymy information, and according to said synonymy information, said audio processing module dynamically adjusts said speech recognition model and recognizes said audio signals inputted by the learner.

4. The system as claimed in claim 1, wherein said audio processing module further includes biased error information, and according to said biased error information, said audio processing module dynamically adjusts said speech recognition model and recognizes said audio signals inputted by the learner.

5. The system as claimed in claim 1, wherein each conversation node for said situational conversation teaching material is directionally connected by at least a node connection line.

6. The system as claimed in claim 1, wherein said situational conversation teaching material is generated according to teaching material edition rules, and said teaching material edition rules include course objective rules, multi-path connection rules, and multi-variation conversation sentence rules.

7. The system as claimed in claim 1, said system outputs information in response to said learner through an output device.

8. The system as claimed in claim 1, said system allows said situational conversation teaching material to have function of setting course objectives.

9. The system as claimed in claim 6, said system allows said course objectives and said conversation sentences to have the function of setting variables.

10. The system as claimed in claim 1, wherein said audio processing module further includes:
a speech recognition module for transmitting said recognition result of said audio signal to said conversation processing module; and
an adaption module, according to said situational conversation teaching material, said biased error information of teaching material and said synonymy information of teaching material, dynamically adjusting said speech recognition model to provide said speech recognition module to perform recognition on the learner's audio signal, performing learner adaption according to learner's audio signal, and adjusting said speech recognition model to improve the speech recognition results.

11. The system as claimed in claim 1, wherein said conversation processing module stores the record of the learner's conversation data.

12. The system as claimed in claim 1, wherein said conversation processing module further includes:
a sentence processing module for determining whether the learner's conversation sentence being correct, synonymous, biased, or mispronouncing, according to said speech recognition results and the information in a database of biased errors and a database of synonyms, and recording data related to the learner's conversation sentence to conversation data; and
a flow processing module for determining at least a subsequent response sentence according to the determination of said sentence processing module.

13. The system as claimed in claim 5, wherein said situational conversation teaching material is generated according to teaching material edition rules, and said teaching material edition rules defines Type 1 to Type 8 connection lines for said directional connection lines.

14. The system as claimed in claim 1, wherein said speech recognition model further includes at least a acoustic model, at least a language model, grammar and dictionary.

15. The system as claimed in claim 7, wherein said output device further includes an image-based human face synthesis module for generating at least a corresponding human face image from sentence or text in response to the learner, and outputting an integrated audio/visual image.

16. The system as claimed in claim 7, wherein said output device further includes an audio synthesis module for transforming sentence or text in response to the learner into audio.

17. The system as claimed in claim 9, said system allows said course objectives and sentences of said conversation node to use the same variable names.

18. The system as claimed in claim 13, wherein said Type 1 connection line is defined as a course basic connection line, and connecting to nodes that can be repeatedly used.

19. The system as claimed in claim 13, wherein said Type 2 connection line is defined as a course basic connection line, and connecting to nodes that cannot be repeatedly used.

20. The system as claimed in claim 13, wherein said Type 5 connection line is defined as a course non-basic connection line, and connecting to nodes that can be repeatedly used.

21. The system as claimed in claim 13, wherein said Type 6 connection line is defined as a course non-basic connection line, and connecting to nodes that cannot be repeatedly used.

22. The system as claimed in claim 13, wherein said Type 7 connection line is defined as a calling connection line, indicating a connection line of flow from a calling node to a starting node.

23. The system as claimed in claim 13, wherein said Type 8 connection line is defined as a returning connection line, indicating a connection line of flow from a starting node to a calling node.

24. The system as claimed in claim 13, wherein said Type 3 connection line is defined as a connection line that can be taken in a conversation flow as long as one of said Type 1 or Type 2 connection lines has already been taken before.

25. The system as claimed in claim 13, wherein said Type 4 connection line is defined as a connection line that can be taken in a conversation flow after all of said Type 1 or Type 2 connection lines have already been taken before.

26. A method for conversation practice in simulated situations, comprising:
preparing a situational teaching material with multi-flow dialogue paths and dialogue sentences having a plurality of replaceable vocabulary items;
dynamically adjusting a speech recognition model according to different contents of said situational conversation teaching material, and recognizing the inputted audio signal of a learner to determine information on recognition results; and
determining information in response to the learner according to said information on said recognition results and said situational conversation teaching material.

27. The method as claimed in claim 26, said method further includes:
if said information in response to the learner is text or audio, generating an image-based human face image and integrating with audio for outputting.

28. The method as claimed in claim 26, said method further includes:
translating text in said information in response to the learner into audio for outputting.

29. The method as claimed in claim 26, said method further includes:
performing directional connection with connection line on each conversation node for said situational conversation teaching material;
defining 8 types of connection lines for said directional connection lines; and
generating a flow of situational conversation teaching material according to said definition of 8 types of connection lines.

30. The method as claimed in claim 26, said method further includes:
adding biased error information or synonymy information to said situational conversation teaching material, said biased error information or said synonymy information detecting whether learner's sentence having biased error or erroneous grammar or having a synonymy sentence to provide said learner with correct understanding and usage for said biased error or erroneous grammar or said synonymy sentence.

31. The method as claimed in claim 26, said method further includes:
adding biased error information and synonymy information to said situational conversation teaching material, said biased error information or said synonymy information detecting whether learner's sentence having biased error or erroneous grammar or having a synonymy sentence to provide said learner with correct understanding and usage for said biased error or erroneous grammar or said synonymy sentence.

32. The method as claimed in claim 26, wherein said situational conversation teaching material is generated according to teaching material edition rules, and said teaching material edition rules include course objective rules, multi-path connection rules and multi-variation conversation sentence rules.

33. The method as claimed in claim 26, wherein said step of determining information in response to the learner according to said information on said recognition results and said situational conversation teaching material further includes:
determining whether the learner's sentence being correct or mispronouncing according to said information on said recognition results, and recording the data related to the conversation sentence to conversation data; and
determining a subsequent response sentence according to said determination, if the learner's sentence being correct, then performing a conversation flow in the next conversation node of said situational conversation teaching material; if the learner's sentence being mispronouncing, then pattern sentence being the conversation sentence in response to the learner.

34. The method as claimed in claim 26, wherein said step of determining information in response to said learner according to said information on said recognition results and said situational conversation teaching material further comprises:
according to said information on said recognition results, determining whether the learner's sentence being correct, synonymous, biased or mispronouncing, and recording data related to conversation sentence to conversation data; and
according to said determination to determine a subsequent response sentence, if said determination is the learner's sentence being correct, synonymous or biased, performing conversation flow in the next conversation node of said situational conversation teaching material; if said determination is the learner's sentence being mispronouncing, pattern sentence being the conversation sentence in response to the learner.

35. The method as claimed in claim 26, wherein said step of determining information in response to said learner according to said information on said recognition results and said situational conversation teaching material further includes:
according to said information on said recognition results, determining whether the learner's sentence being correct, erroneous, synonymous or biased, and recording data related to conversation sentence to conversation data; and

36. according to said determination to determine a subsequent response sentence, if said determination is the learner's sentence being correct, synonymous or biased, performing conversation flow in the next conversation node of said situational conversation teaching material; if said determination is the learner's sentence being mispronouncing, pattern sentence being the conversation sentence in response to the learner.
